(19) United States
(12) Patent Application Publication
(10) Pub. No.: US 2026/0276978 A1
(43) Pub. Date: Sep. 17, 2026

(54) HEAD UP DISPLAY WITH REDUCED GHOST ARTIFACTS

(71) Applicant: HARMAN BECKER AUTOMOTIVE SYSTEMS GMBH, Karlsbad (DE)

(72) Inventor: Harald SANFTMANN, Eching (DE)

(73) Assignee: HARMAN BECKER AUTOMOTIVE SYSTEMS GMBH, Karlsbad (DE)

(21) Appl. No.: 19/168,174

(22) PCT Filed: Mar. 24, 2023
(86) PCT No.: PCT/EP2023/057649

§ 371 Date: Sep. 23, 2025

(51) Int. Cl. G02B 27/00; G02B 27/01

(52) U.S. Cl. CPC G02B 27/0018; G02B 27/0101; G02B 2027/011; G02B 2027/012; G02B 2027/014

(57) ABSTRACT

The application relates to a method for providing image data for a projection on a windscreen, the method comprising at an image processing unit the steps of determining an inverse filter function u to be used to remove ghost artifacts which occur when the image data are projected on the windscreen, determining a first image f to be projected on the windscreen, and determining a ghost function representing the ghost artifacts by which the first image to be projected is distorted when projected on the windscreen. The inverse filter is applied to the first image f in order to generate a filtered image, and the filtered image is provided to a projecting apparatus configured to project the filtered image onto the windscreen.

### TECHNICAL FIELD

The present application relates to a method for providing image data for a projection on a windscreen, to an image processing unit configured to provide the image data for the projection. Furthermore, a display system is provided comprising a projection apparatus and the image processing unit and a computer program comprising program code.

### BACKGROUND

A head up display, HUD, is a device which allows virtual content to be rendered in the field of view of an observer. In an automotive context the observer is a driver of a vehicle, in a fighter jet or any other airplane it is the pilot. The main idea behind a head up display is to let a display be reflected of a windshield/windscreen to create a virtual image at some distance. The light from the display is reflected by an inner and an outer side of the windscreen. The former is resulting in the primary image whereas the latter in the ghosting image.

To fight ghosting, a wedge is added to the windscreen which makes the outer reflection project to the same position as the primary reflection. This wedge however adds significant costs to the windscreen. Without such a wedge a head up display suffers from serious ghosting artifacts. Accordingly a need exists to provide a possibility to reduce or remove the ghosting artifacts for a head up display, especially when no additional wedge is used on the windscreen.

### SUMMARY

This need is met by the features of the independent claims. Further aspects are described in the dependent claims.

According to a first aspect a method for providing image data for projection on a windscreen is provided wherein an image processing unit determines an inverse filter function u to be used to remove ghost artifacts which occur when the image data are projected on the windscreen. Furthermore a first image f is determined to be projected on the windscreen and a ghost function is determined representing the ghost artifacts by which the first image to be projected is distorted when projected on the windscreen. The inverse filter is applied to the first image f in order to generate a filtered image v and the filtered image v is provided to a projecting apparatus which is configured to project the filtered image onto the windscreen.

According to one aspect the order of the application of the inverse filter is such that the inverse filter is applied even before the artifacts occur during display. Accordingly the inverse filter can be applied before sending the filtered image for display and during the projection the ghost will be applied so that the two effects will cancel out and a clear image is obtained without ghosting. This is mainly due to the fact that the mathematical operations occurring in the different processing steps are linear operations so that the order of the application of the filter does not play a role.

Furthermore the corresponding image processing unit is provided comprising a memory and at least one processor wherein the memory contains instructions executable by the at least one processor, wherein the image processing unit is configured to operate as discussed above or as discussed in further detail below.

Furthermore a display system is provided configured to project the image data on a windscreen wherein the display system comprises a projecting apparatus configured to project a filtered image onto the windscreen, the display system furthermore comprising the image processing unit as mentioned above or as discussed in further detail below.

Furthermore a computer program comprising program code is provided which is to be executed by at least one image processing unit, wherein execution of the program code causes the at least one image processing unit to carry out a method as mentioned above or as discussed in further detail below.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements.

FIG. 1 is a schematic architectural view of a display system comprising a projecting apparatus and an image processing unit in which ghost artifacts occurring when projecting image data to a windscreen can be reduced.

FIG. 2 shows a schematic view of an input image including a content to be displayed by the system of FIG. 1.

FIGS. 3a and 3b show a schematic view of an example image displayed on a display system shown in FIG. 1 without applying features of the invention and a synthetically generated image including ghost artifacts.

FIG. 4 provides a schematic view of how image pixels are amended in view of a ghost artifact.

FIG. 5 shows a schematic view of an inverse filter applied to an image with ghosts as shown in FIG. 4.

FIG. 6 shows a schematic view of image processing steps carried out in one embodiment using inverse filtering.

FIG. 7 shows a further schematic view of the image processing steps according to another embodiment using inverse filtering.

FIG. 8 is an example flowchart of a method used for avoiding ghost artifacts in a projection of image data in a system of FIG. 1.

FIG. 9 shows a further example view of an image as processed by the image processing unit when combining different filter options.

FIG. 10 shows an example schematic view of an image processing unit configured to apply the image processing steps in a system as shown in FIG. 1.

### DETAILED DESCRIPTION

In the following, embodiments of the invention will be described in detail with reference to the accompanying drawings. It is to be understood that the following description of embodiments is not to be taken in a limiting sense. The scope of the invention is not to be intended to be limited by the embodiments described hereinafter or by the drawings which are to be illustrative only.

The drawings are to be regarded as being schematic representations, and elements illustrated in the drawings are not necessarily shown to scale. Rather, the various elements are represented such that their general function and purpose becomes apparent to a person with skill in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof. In the following, the ghosting is described mathematically and then an inverse filtering approach is described in more detail which is used to eliminate the ghosting. Later, several methods are presented used to modify the input image in a way that any intermediate images occurring during the processing do not have negative light values.

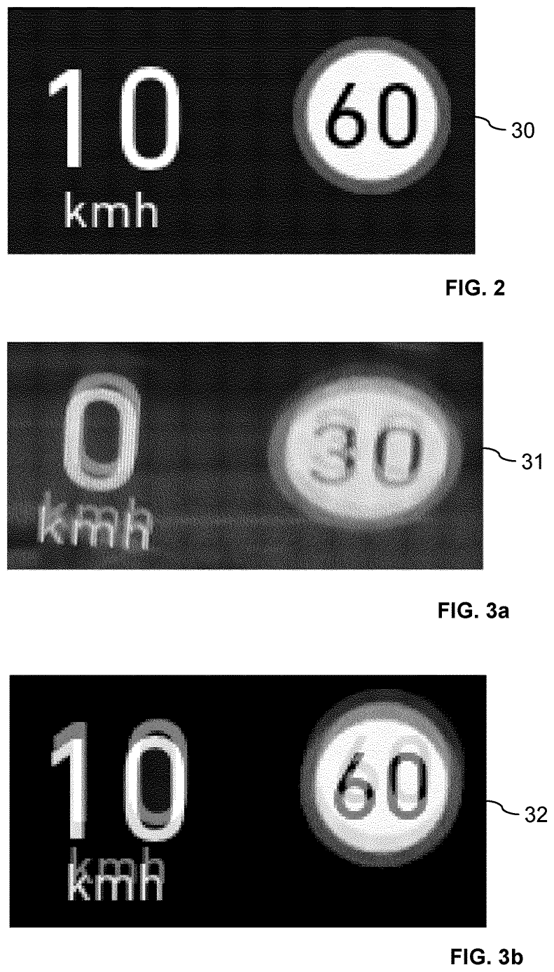

To model a ghosting in a mathematical way where the basis is an input image comprising content to be displayed on a windscreen, with FIG. 2 showing a possible example of such an input image 30.

5 Ghosting can be modeled by a simple convolution where the convolution kernel for the ghosting is given by the function:

$$g ( x , y ) = \{ \begin{matrix}1 - m & if x = 0 , y = 0 , \\ m & if x = {t}_{x} , y = {t}_{y} , \\ 0 & else .\end{matrix}$$

Where tₓ, t_{y} is the offset of the ghosting with respect to the input image and m is the ghosting magnitude with respect to the total reflected light.

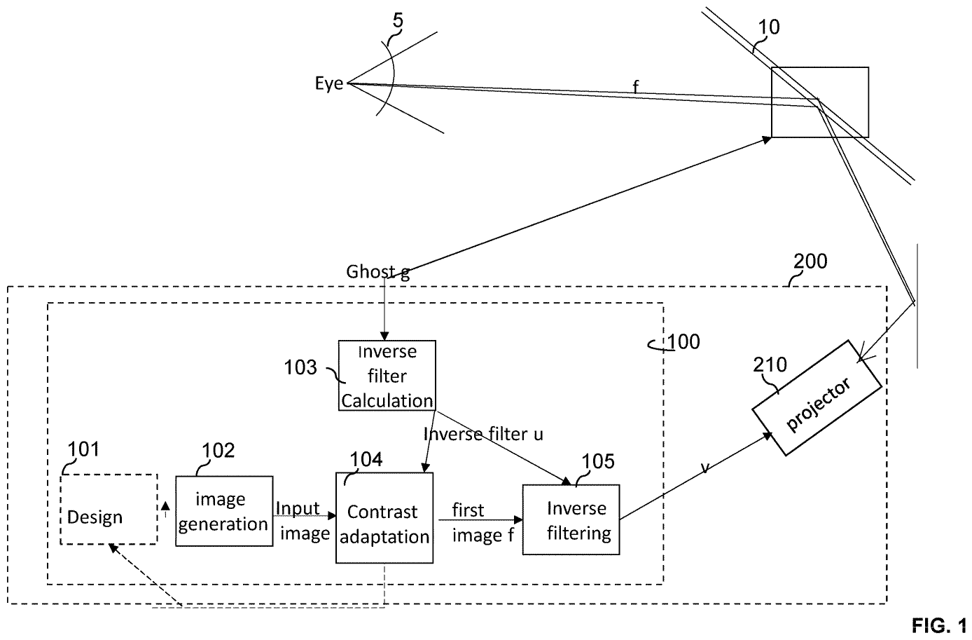

FIG. 1 is a schematic view of a display system such as a head up display HUD which can present information which can be used to display information to a user such as a driver where the information is projected onto a transparent screen such as windscreen 10. The display system comprises an image processing unit 100 which does an image processing such that any ghost artifacts occurring when an image is projected and reflected by the windscreen 10 are removed. The system 200 comprises a projecting apparatus 210 and the image processing 100. The projecting apparatus 210 uses a mirror 20 to project the image data to the windscreen 10 and as the windscreen comprises an inner and outer surface the actual image and a ghost image is generated which is visible to a user 5 looking through the windscreen where the eye of the user is schematically shown in FIG. 1.

In the architectural view of FIG. 1 the different processing steps carried out in the image processing unit 100 are schematically shown with functional entities and it should be understood that the different functional entities shown in FIG. 1 needed not to be implemented as shown but could be implemented by a program code to be executed by a processing unit as discussed in connection with FIG. 10. In the vehicle a system such as a head unit can be provided which determines information to be displayed to the user through the head up display as shown in FIG. 1 so that content to be displayed is designed in a design unit 101 and an input image to be displayed. An example of such an input image can include the current velocity of the vehicle in which the system is used, a speed limitation, a heading direction or any other information.

The image 30 as shown in FIG. 2 can be generated by image generation unit 102 which produces the input image. Furthermore, the ghost artifacts are determined in an inverse filter calculation unit 103 and a contrast adaptation unit 104 may be provided for a contrast adaptation as will be discussed below. The output of the contrast adaptation is a first image f which is to be projected onto the windscreen. An inverse filtering unit 105 applies the inverse filter to already undo in a ghost artifacts which will occur during the projection but which have not yet occurred. The already filtered image is fed to a projecting apparatus 210 which then does the projection onto the windscreen 10.

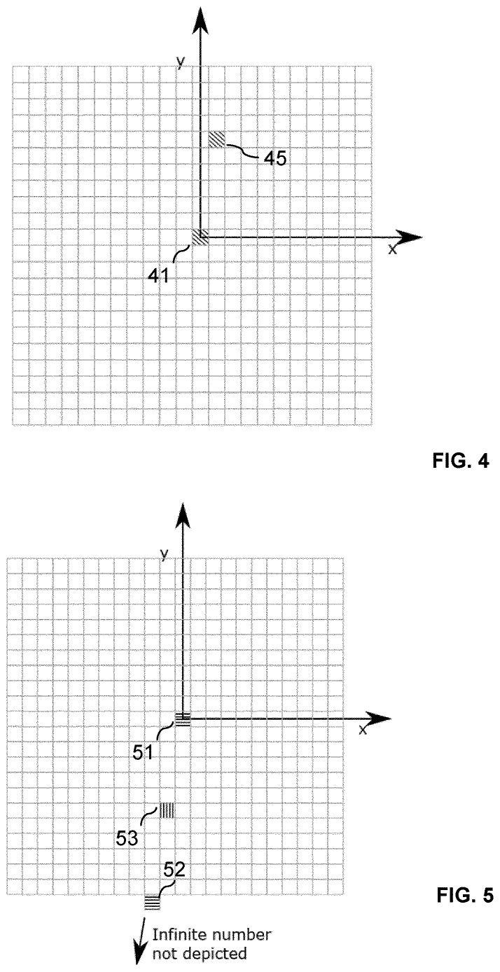

As can be seen from FIG. 3A severe ghosting is introduced and visible in the displayed image 31 when no countermeasures are taken. In general effective countermeasure require a thorough understanding of the problem, here how the ghost is generated. FIG. 3B now shows the result of applying the ghost as indicated by equation 1 to the input image using the example settings of tₓ=1,t_{y}=6,m=⅕ resulting in image 32. The ghost filter is also shown in FIG. 4 which indicates that the filter, the convolutional filter model for ghosting only has to two non-zero entries. The contribution of the primary image 41 at the origin and the contribution of the ghosting 45 at the corresponding pixel position. The grid indicates the pixels.

By comparing the synthetic image shown in FIG. 3B and the one as generated by a head up display as shown in FIG. 3A, it can be deduced that a model such as the one indicated in equation 1 correctly reproduces the ghosting, namely the pixel exact brightness values and even the aliasing of the font does match.

Inverse filtering is a known technology for image enhancement. By knowing the linear filter which distorted an image one can undo the introduced artifacts. Let f be the original image, also called first image that should be displayed. Let g be a convolution kernel with which the signal is convolved. The resulting image is b=f\circ g with \circ being the convolution operator. The reconstructed original image is f=b. u where u can be calculated as:

$$u = {ℱ}^{- 1} ( \frac{1}{ℱ ( g )} )$$

where [symbol] denotes the Fourier transform. In the present case the fast Fourier transformation (FFT) is used to calculate u and normalize the results, so all coefficients sum to

$$1 : {\sum }_{i = 0}^{inf} {u}_{i} = 1 ,$$

where uᵢ are the non-zero coefficients of u and the index i is increasing according to the distance from the origin. u has the form:

$$u ( x , y ) = \{ \begin{matrix}{u}_{i} & if x = - {it}_{x ,} y = - {it}_{y ,} \\ 0 & else\end{matrix} .$$

Where, i is a positive number including 0.

Using inverse filtering the application of g can be undone. The result is the image where ghosting has been eliminated. The inverse filter u is illustrated in FIG. 5. Table 1 lists the largest weights of u. There are by principle infinite many non-zero entries in u. For any practical purposes computation needs to be limited. Notice, the magnitude of uᵢ is declining rapidly with distance from the origin. Thus one can only use the first k weights. The value of k can be determined based on the inspection of the inverse filtering results. Should there still be ghosting artifacts, k should be increased. In the example case k=3 was used.

TABLE 1
The largest 15 weights of the inverse filter u.

| i | xᵢ | yᵢ | uᵢ |
|---|---|---|---|
| 0 | 0 | 0 | 1.250000097453239 |
| 1 | −1 | −6 | −0.3125002143554513 |
| 2 | −2 | −12 | 0.07812514858493360 |
| 3 | −3 | −18 | −0.01953126814701925 |
| 4 | −4 | −24 | 4.882798037540658e−3 |
| 5 | −5 | −30 | −1.220703309227995e−3 |
| 6 | −6 | −36 | 3.051760172991403e−4 |
| 7 | −7 | −42 | −7.629400432478508e−5 |
| 8 | −8 | −48 | 1.907350108119627e−5 |
| 9 | −9 | −54 | −4.768384769906145e−6 |
| 10 | −10 | −60 | 1.192094292555121e−6 |
| 11 | −11 | −66 | −2.980235731387802e−7 |
| 12 | −12 | −72 | 7.450579828862428e−8 |
| 13 | −13 | −78 | −1.862644957215607e−8 |
| 14 | −14 | −84 | 4.656631392253171e−9 |

Since the convolution is a linear operation, the order of the application of the filters does not play a role. Accordingly, it is possible to undo the artifacts or ghosts even before they happen or occur. Applied to the present situation this means that the inverse filter u can be applied to the image data before sending the image to a head up display for display and the head up display will apply the ghost g so that the two will cancel out and a clear image is obtained.

Accordingly the procedure for removing the ghost artifacts in general is as follows:

In a first step the ghost function is determined, a function such as the function shown in Equation. 1 wherein the ghost function may be determined by evaluating the images including the ghost artifacts. In a second step the inverse filter u is determined, by way of example as shown in Eq. 3 or in FIG. 5. In FIG. 5 the inverse filter u has in theory an infinite number of non-zero entries wherein in FIG. 5 the horizontally hatched entries 51 and 52 have positive entries wherein the vertically hatched areas such as entry 53 has negative values wherein the non-hatched areas are zero. In a further step, the inverse filter is applied to a first image f wherein the result is called the filtered image v. In the next step this filtered image is sent to the projecting apparatus such as apparatus 210 of FIG. 1 and in step 5 during the projection the ghosting artifact g is introduced. As a result the user or driver sees the filtered image without the ghosting artifacts.

In the following it is explained how it is possible to deal with negative light in the present context.

Unfortunately the original image convolved with the inverse filter may result in negative pixel values. In the following 2 cases may be considered with a single transition of the image intensity in the image from white, having a pixel value of 1 to black having a pixel value of 0. In the first case the transition of the pixel value is from black to white and in the second case a transition from white to black is considered.

In the first case the output of inverse filtering would be the value u₀, since all other values are multiplied with black which has the value of zero, notice u₀>1. In the second case it would be

$${\sum }_{i = 1}^{inf} {u}_{i} = 1 - u ,$$

which is <0. So in the first case one would need more light that the system can output and in the second case one would need negative light. Neither can one output more light than the system is designed for nor is it possible to physically realize negative light using LCDs. So one needs to make sure no negative values occur. This can be done by adding some brightness to the input image and reducing the contrast somewhat. Theoretical background on this method is given by [SW]. To calculate the contrast reductions let ωₗ be the value which one maps black to, and ωₕ be the value which one can map white to. The constraints we can therefore reformulate as:

$${u}_{0} {ω}_{h} + ( 1 - {u}_{o} ) {ω}_{l} <= 1$$

$${u}_{0} {ω}_{l} + ( 1 - {u}_{0} ) >= 0$$

Needed are non-trivial solutions with the property ωₕ−ωₗ being maximized. This is such a solution to the equations above:

$${ω}_{h = \frac{{u}_{0}}{2 {u}_{0} - 1}}$$

$${ω}_{l = \frac{{u}_{0} - 1}{2 {u}_{0} - 1}}$$

In our example u₀=1.250000097453239, 0 ωₕ=0.8333332900207883 and ωₗ=0.1666667099792117. Using the calculated values above ghosting caused by single transitions can be eliminated. However, in case there two transitions, from black to white and to black again or vice versa, the contrast reductions is not sufficient to eliminate ghosting entirely. In the following focus is put on two transitions, again with two cases: one where a white strip is covering u₁ and all other coefficients are covered with black. As well as the inverse input. This leads to these two equations:

$${u}_{1} {ω}_{l} + ( \frac{{u}_{1}}{2 {u}_{1} - 1} )$$

$${u}_{1} {ω}_{h} + ( \frac{{u}_{1} - 1}{2 {u}_{1} - 1} )$$

In this example u₁=−0.3125002143554513, so vₕ=0.8076922265163002 and vₗ=0.1923077734836998.

The filter u is applied to the modified input image. This image is sent to the HUD for display. Notice that this image does contain very dark pixels, but these are quite local. The HUD outputs a perfect reconstruction of the modified input.

In the following another approach is discussed which is called dilate approach.

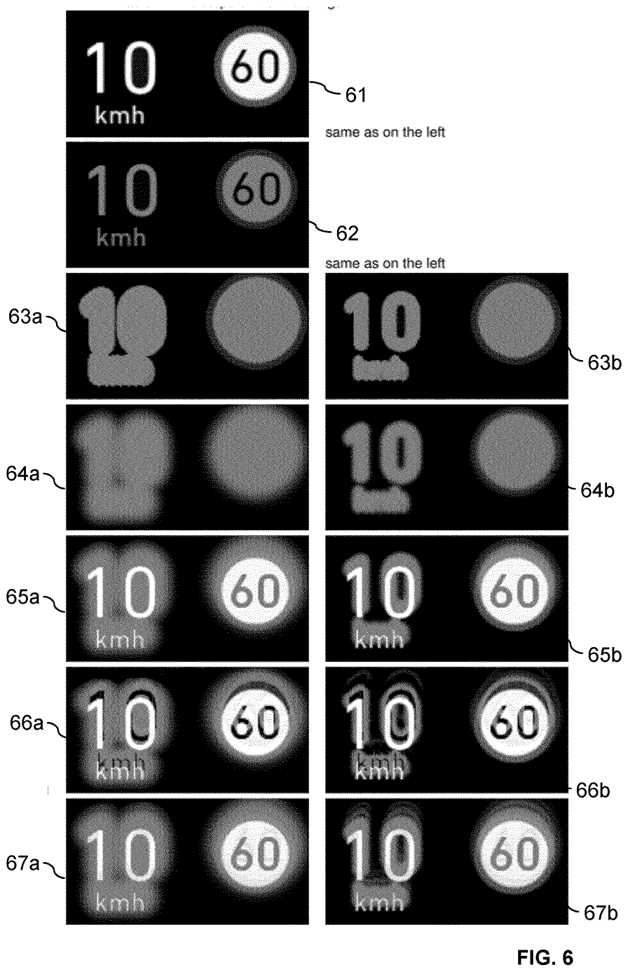

The method presented in the previous section reduced the contrast globally. In this section a method is presented which only locally increase the brightness of the input image so one can again have completely dark areas on the HUD, given they are sufficiently far away from the bright pixels. Some key observation lead to the dilate method. One cannot get darker than the ghost itself if the target is to eliminate it entirely, which is still the goal. So to get rid of the hard ghosting edges one can add more light to the neighbouring pixels. There is one degree of freedom: how fast does this additional light fade out. This is a parameter to the algorithm, called s. The algorithm has only one-linear operation: dilate, this is where the current name comes from. The steps are as follows, also shown in FIG. 6 discussed below.

The dilated approach is discussed in connection with FIG. 6 where in a first step the input image to be displayed such as image 61 is provided. In a further step the input image 61 is convolved with the ghosting contribution only. It is just shifting the pixels and making them darker according to the ghosting contribution as shown by image 62 of FIG. 6. In the third step a dilate operation is applied on the result with the size s wherein the output is called dilate. In the example of FIG. 6 two values are illustrated. In image 63A seven pixels are used for the dilate operation whereas in image 63B three pixels were used for the dilate operation. The next step a size s blur filter is applied resulting in a blurred image as shown by the image 64A and 64B. In step 5 a maximum operation of the input and the blur image is calculated so that maximum images 65A and 65B are generated. In step 6 the inverse filtering is applied resulting in images 66A and 66B. The image is fed to the projecting apparatus where the ghosting is applied and the user or driver sees an image partially without ghosting resembling the maximum images as shown by images 67A and 67B.

In the following another approach is discussed which is called local approach hereinafter. In the previous section of the dilate approach, the brightness values of individual pixels, were considered to prevent the need for a negative light. However, this approach does not take into account the case where more light would be needed than the system can produce. This shortcoming is addressed in the following local approach. The method is using similar operations to the one above but works on a different principal. The inverse filter is applied on the input image to obtain an image having negative values as well as values larger than 1. Further it is assumed that the inverse filtering is a function h which maps the range from [0,1] to a new range [a, b] and it is assumed that h is a linear function only depending on the pixel value itself. Accordingly a function is searched which maps the range from [0,1] to a smaller range [c, d], with a<=0, b>=1, c>=0 und d<=1, so if the inverse filter h is applied here again the range between 0 and 1 is obtained.

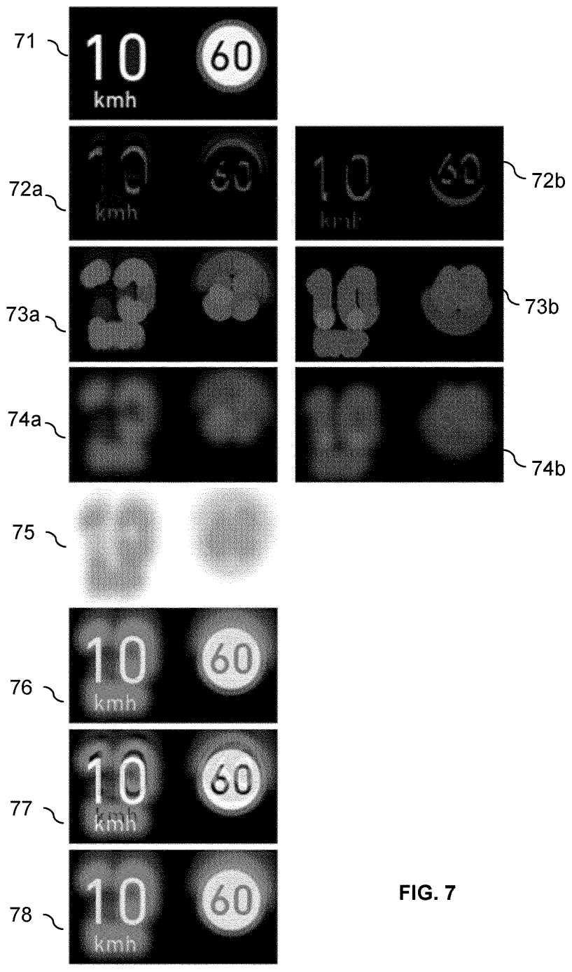

The processing steps are also discussed in connection with FIG. 7 below. In a first step the input image 71 is provided. In the second step, a maximum operation is carried out where the inverse filter is applied to a negative part of the input image in order to generate a minimum image 72A, which is also called outside_{low}.

The operation is max(0-inverse filtering applied to the input image, 0).

Furthermore, a maximum operation is carried out on an image where the inverse filter is applied to the input image and the result of the application is inversed in order to generate a maximum image 72B which is also called outside_{high}.

The operation is max (Inverse filtering applied to the input image −1, 0).

On the results of the maximum and the minimum image, outside_{low} and outside_{high} a dilate operation is applied with the size s wherein the output is called dilate_{low} and dilate_{high}, respectively. In the example s=7 pixels was used. The result are the corresponding images 73A and 73B. In this next step, a blur filter is applied with the size s which results in the images 74A and 74B and which are also called blur_{low} and blur_{high}. In the following step a range image 75 is generated calculated as follows: 1/(blur_{low}+1+blur_{high}), called range. In the following step an image is calculated using the input and the blurred minimum image which is called rangeoffset and is calculated as follows: (input image+blur_{low})*range and which is the modified input to the inverse filtering.

In the next step the inverse filter u is applied which results in image 77 and this image is then applied to the projecting apparatus so that the user sees an image without ghosting such as image 78, but otherwise resembles the image 77.

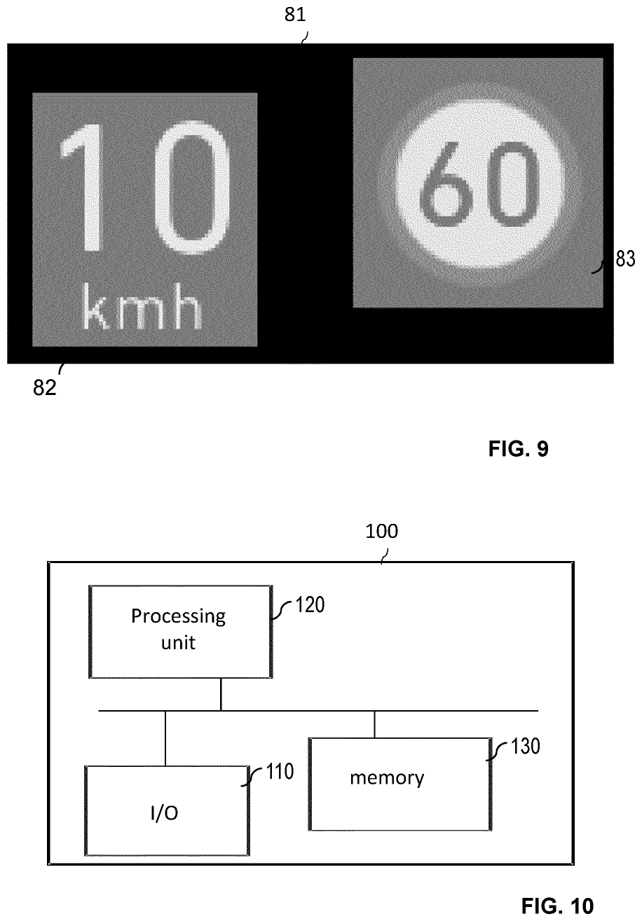

In the following a further approach is discussed which is called a redesign approach. The local approach discussed in connection with FIG. 7 combined with the inverse filtering can eliminate the ghosting. However, this comes at the price that the design of the content is changed by the applied algorithm. A further option is to design the content with the limitation of the hardware in mind and avoid sudden transitions from black to white in the first place. This algorithm would still perform all the necessary adjustments but these will introduce substantially less noticeable changes. This redesign can be as simple as cropping the corresponding regions out of the global approach image. FIG. 9 shows an example image 81 accordingly the two sections 82 and 83 are identified in the image containing the content and within these sections 82, 83 the local approach may only be applied to these sections and the ghosting is eliminated through the inverse filtering method, however the design is only slightly altered.

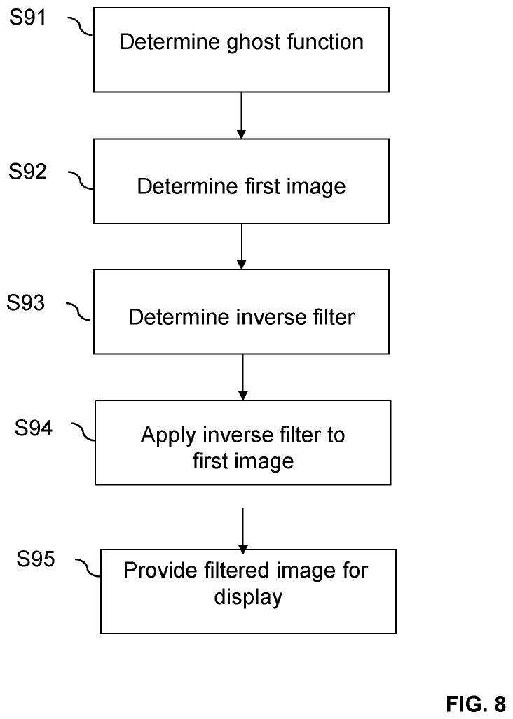

FIG. 8 shows some of the main steps carried out in a different embodiment discussed above. In step S91 the ghost function is determined which represents the ghost artifacts by which the first image to be projected is distorted when projected on the windscreen is determined. In FIG. 4 the image containing the ghost was shown comprising the contribution 41 of the image and the contribution of the ghost 45. Furthermore, a first image is determined in step S92 which should be projected on the windscreen. Referring to FIG. 1 the first image was the image which was already a modulated image in which some brightness values were amended relative to an input image which shows the content to be displayed. Furthermore, in step S93 the inverse filter is determined. FIG. 5 shows an example of the inverse filter. In step S94 the inverse filter is then applied to this first image in order to generate a filtered image and the filtered image is provided to the projecting apparatus 210 which projects the filtered image onto the windscreen. During the step S95 a ghost is introduced but as the ghost artifacts were removed beforehand, a substantially ghost-free image is visible to the user or driver.

FIG. 10 shows a schematic architectural view of the image processing apparatus 100 also shown in FIG. 1 whereas in FIG. 1 the image processing apparatus is shown with the corresponding functional entities carrying out the different image processing steps. The image processing entity comprises an interface 110 which is provided for transmitting user data or images or control messages to other entities such as the projecting apparatus and is provided for receiving user data or control information or images or information to be displayed from other entities such as the information about the ghost. The image processing apparatus furthermore comprises a processor 120 which is responsible for the operation of the image processing unit 100. The processor 120 can comprise one or more processing elements and can carry out instructions stored on a memory 130, wherein the memory may include a read-only memory, a random access memory, a mass storage, a hard disk, or the like. The memory 130 can furthermore include a suitable program code to be executed by the processor 120 so as implement the above-described functionalities in which the processing unit 100 is involved.

From the above said some general conclusions can be drawn:

According to one aspect of the image processing method the inverse filter is applied even before the filtered image is provided to the projecting apparatus. This means that the ghost artifacts are removed even before they occur during the projection step.

Furthermore, the first image f can be a modulated image in which the brightness values of at least some of the pixels of an input image such as image 30 shown in FIG. 2 are adapted relative to the input image wherein the input image includes the content to be displayed on the windscreen.

The modulated image may have a lower contrast between the brightest possible pixel value and the lowest possible pixel value than the input image. Here it is possible to reduce the contrast for all pixels of the input image.

In a further embodiment it is possible to increase the brightness values for the modulated image only for a subset of the pixels of the input image and not for all pixels. The location of the subset of the pixels in a modulated image may be determined based on the location of the ghost artifacts. Here one option was the dilate approach, wherein in this approach it is possible to determine ghost regions in an input image where the ghost artifacts change the pixel values of the input image. Furthermore, the ghost regions are increased by neighbouring pixels located within a defined distance to the pixels located in the ghost regions in order to degenerate dilate regions including the ghost regions and the neighbouring pixels. In addition a blurring is applied to the dilate regions in order to generate blurred regions as discussed above in connection with images 64A and 64B. Furthermore, for each pixel in the blurred regions, a maximum value is determined from the input image and the blurred region in order to generate a maximum image, and the inverse filter is applied to this maximum image.

Furthermore it is possible, as discussed in the local approach that for determining the subset of the pixels, a possible pixel value range is converted that can be projected by the projecting apparatus, to a new value larger than the possible pixel value range using the inverse filter. Furthermore a range function is determined with which the new value range is mapped to an adapted range having pixel values within the possible value range. This was discussed above as part of the local approach here for determining the subset of pixels a first ghost is determined of the input image with applying the inverse filter to the input image and inversing a result of the application of the inverse filter in order to generate the maximum image such as image 72b. Furthermore, a second ghost of the input image is determined with the application of the inverse filter to a negative of the input image in order to generate a minimum image as shown by 72a. Furthermore, the first and second ghosts are increased by neighbour pixels located within a defined distance to the pixels of the first and second ghost in order to generate dilate regions including the first and second ghost and the neighbouring pixels as discussed above in connection with images 73a and 73a. The first and second ghost are then increased by neighbouring pixels located within the defined distance to pixels in order to generate the dilate region including the first and second ghost and their neighbouring pixels.

Furthermore it is possible that based on the input image and the inverse filter at least one outside image is generated having image intensity values larger or smaller than the possible intensity values that can be projected by the projecting apparatus. Then a range image may be determined based on the at least one outside image having image intensity values in a smaller range smaller than the maximum range defined by the possible intensity values that can be projected by the projecting apparatus. Furthermore, an inverse filter is then applied to an offset image which is generated based on the range image and which comprises image intensity values in the smaller range than the possible intensity range in order to determine the modulated image, wherein the application of the inverse filter increases the intensity values of the offset image to the maximum range. This was discussed above in connection with the local approach.

The generation of the at least one outside image can include the application of an inverse filter to the input image and determining a first outside image having intensity values larger than the possible intensity values and second outside image having intensity values smaller than the possible intensity values wherein the range is determined based on the first outside image and the second outside image. A dilate operation can then be applied to the pixels of the first outside image having intensity values larger than a possible intensity values in order to generate a first dilated outside image and the dilate operation is applied to pixels of the second outside image having intensity values smaller than the possible intensity values in order to generate a second dilated outside image, wherein a blur filter is applied to the first and second outside image in order to generate a blurred first and second outside image and the range image is determined based on the first and second blurred outside image.

The offset image may be determined based on the first and second blurred image and the range image.

1. A method for providing image data for a projection on a windscreen, the method comprising at an image processing unit:
determining an inverse filter function to be used to remove ghost artifacts which occur when the image data are projected on a windscreen
determining a first image to be projected on the windscreen,
determining a ghost function representing the ghost artifacts by which the first image to be projected is distorted when projected on the windscreen,
applying the inverse filter to the first image fin order to generate a filtered image, and
providing the filtered image to a projecting apparatus configured to project the filtered image onto the windscreen, wherein the first image is a modulated image in which brightness values of at least some of pixels of an input image are adapted relative to the input image, wherein the brightness values are increased for the modulated image for a subset of the pixels of the input image.

2. The method of claim 1, wherein the inverse filter is applied before the filtered image is provided to the projecting apparatus.

3. (canceled)

4. The method of claim 1, wherein the modulated image has a lower contrast between the brightest possible pixel value and the lowest possible pixel value than the input image.

5. The method of claim 1, wherein the contrast of the modulated image is reduced for all pixels of the input image.

6. The method of claim 1 wherein a location the subset of the pixels in the modulated image is determined based on a location of the ghost artifacts.

7. The method of claim 6, wherein determining the subset of pixels includes:
determining ghost regions in the input image where the ghost artifacts change the pixel values of the input image,
increasing the ghosts regions by neighbouring pixels located within a defined distance to pixels located in the ghost regions in order to generate dilate regions including the ghost regions and the neighbouring pixels,
applying a blurring to the dilate regions in order to generate blurred regions,
determining, for each pixel in the blurred regions, a maximum value from the input image and the blurred region in order to generate a maximum image, wherein the inverse filter is applied to the maximum image.

8. The method of claim 6, wherein determining the subset of pixels includes converting a possible pixel value range to be projected by the projecting apparatus, to a new value range larger than the possible pixel value range using the inverse filter, and determining a range function with which the new value range is mapped to an adapted range having pixel values within the possible value range.

9. The method of claim 8, wherein determining the subset of pixels includes:
determining a first ghost of the input image with applying the inverse filter to the input image and inversing a result of the application of the inverse filter in order to generate a maximum image,
determining a second ghost of the input image with applying the inverse filter to a negative of the input image in order to generate a minimum image,
increasing the first and second ghost by neighbouring pixels located within a defined distance to pixels of the first and second ghost in order to generate dilate regions including the first and second ghost and the neighbouring pixels.

10. The method of claim 9, further comprising:
based on the input image and the inverse filter, generating at least one outside image having image intensity values larger or smaller than possible intensity values that can be projected by the projecting apparatus,
determining a range image based on the at least one outside image having image intensity values in a smaller range smaller than a maximum range defined by the possible intensity values,
applying the inverse filter to an offset image which is generated based on the range image and comprises image intensity values in the smaller range in order to determine the modulated image, wherein the application of the inverse filter increases the intensity values of the offset image to the maximum range.

11. The method of claim 10, wherein generating the at least one outside image includes applying the inverse filter to the input image and determining a first outside image having the intensity values larger than the possible intensity values, and a second outside image having intensity values smaller than the possible intensity values, wherein the range image is determined based on the first outside image and the second outside image.

12. The method of claim 11, wherein a dilate-operation is applied to pixels of the first outside image having intensity values larger than the possible values in order to generate a first dilated outside image and to pixels of the second outside image having intensity values smaller than the possible intensity values in order to generate a second dilated outside image, wherein a blur filter is applied to the first and second outside image in order to generate a blurred first and second outside image, wherein the range image is determined based on the first and second blurred first and second outside image.

13. The method of claim 12, wherein the offset image is determined based on the first and second blurred image and the range image.

14. An image processing unit comprising:
a memory and at least one processor, the memory containing instructions executable by the at least one processor,
wherein the processor is configured to
determine an inverse filter function to be used to remove ghost artifacts which occur when image data is projected on the windscreen,
determine a first image to be projected on a windscreen,
determine a ghost function representing the ghost artifacts by which the first image to be projected is distorted when projected on the windscreen,
determine an inverse filter function to be used to remove the ghost artifacts,
apply the inverse filter to the first image in order to generate a filtered image, and
provide the filtered image to a projecting apparatus configured to project the filtered image onto the windscreen.

15. The image processing unit of claim 14, the processor is further configured to apply the inverse filter before providing the filtered image to the projecting apparatus.

16. The image processing unit of claim 15, the processor is further configured to provide the first image as modulated image in which brightness values of at least some pixels of an input image are adapted relative to the input image, the input image including a content to be displayed on the windscreen.

17. The image processing unit of claim 16, wherein the modulated image has a lower contrast between the brightest possible pixel value and the lowest possible pixel value than the input image.

18. The image processing unit of claim 17 wherein the processor is further configured to reduce the contrast in the modulated image such that for all pixels the contrast is reduced relative to the input image.

19. The image processing unit of claim 17, wherein the processor is further configured to increase the brightness values for the modulate image for a subset of the pixels of the input image, wherein a location the subset of the pixels in the modulated image is determined based on a location of the ghost artifacts.

20. The image processing unit of claim 19, wherein the processor is further configured, for determining the subset of pixels, to:
determine ghost regions in the input image where the ghost artifacts change the pixel values of the input image,
increase the ghosts regions by neighbouring pixels located within a defined distance to pixels located in the ghost regions in order to generate dilate regions including the ghost regions and the neighbouring pixels,
apply a blurring to the dilate regions in order to generate blurred regions,
determine, for each pixel in the blurred regions, a maximum value from the input image and the blurred region in order to generate a maximum image, wherein the inverse filter is applied to the maximum image.

21. The image processing unit of claim 19, wherein the processor is further configured, for determining the subset of pixels, to convert a possible pixel value range that can be projected by the projecting apparatus to a new value range larger than the possible pixel value range using the inverse filter, and to determine a range function with which the new value range is mapped to an adapted range having pixel values within the possible value range.

22. (canceled)

23. (canceled)

24. (canceled)
